(19) United States
(12) Patent Application Publication
(10) Pub. No.: US 2024/0011905 A1
(43) Pub. Date: Jan. 11, 2024

(54) Calibration System and Method

(71) Applicant: Nippon Telegraph and Telephone Corporation, Tokyo (JP)

(72) Inventors: Suzuyo Inoue, Musashino-shi, Tokyo (JP); Yuzuru Iwasaki, Musashino-shi, Tokyo (JP); Michiko Seyama, Musashino-shi, Tokyo (JP); Kenta Fukada, Musashino-shi, Tokyo (JP)

(21) Appl. No.: 18/041,050

(22) PCT Filed: Sep. 1, 2020
(86) PCT No.: PCT/JP2020/033032

§ 371 Date: Feb. 8, 2023

(51) Int. Cl. G01N 21/552

(52) U.S. Cl. CPC G01N 21/553

(57) ABSTRACT

An acquisition device acquires peak-like shape data measured by a measurement method capable of obtaining waveform data having a peak indicating a feature of a measurement object as a measurement result. An arithmetic device reconstructs the peak-like shape data by using a part of a plurality of bases obtained by performing the Karuhunen-Loeve transform on the peak-like shape data. The arithmetic device reconstructs the peak-like shape data by using a first base, a second base, a third base, and a fourth base obtained by performing the Karuhunen-Loeve transform on the peak-like shape data.

### TECHNICAL FIELD

The present invention relates to a calibration system and a method for reconstructing waveform data having a peak indicative of a feature of an measurement object obtained by measurement.

### BACKGROUND ART

Recognition of a peak shape and calibration using position and height of the peak shape as a reference of waveform data having a peak indicating a feature of a measurement object as a measurement result are frequently used. For example, when the molecular weight is determined or the concentration of the target molecule is determined by chromatography, the feature amount is calculated from the peak position peak size, and the like in waveform data obtained by the measurement, and the molecular weight and the concentration of the target molecule are calculated.

In a confocal microscope, the peak related to the objective distance at which the scattered light from the object becomes the brightest on the projection surface is obtained from the obtained waveform data, and the thickness of the sample is measured. In a fluorescence resonance energy transfer method (FRET), the distance between molecules is evaluated from the wavelength shift indicated by the peak position of the obtained fluorescence spectrum. In a surface plasmon resonance method, the incident angle dependency of the reflection intensity is obtained, and the refractive index is obtained from the profile (waveform data) of the obtained incident angle dependency. In these processes, the position and height of the peak are calculated from the waveform data of the peak-like shape and converted into measured values.

### CITATION LIST

### Non Patent Literature

[NPL 1] by Keiei Kudo, “Basis and method of spectroscopy”, Ohmsha, published in 1985.

[NPL 2] K. Kurihara et al., “Asymmetric SPR sensor response curve-Rtting equation for the accurate determination of SPR resonance angle”, Sensors and Actuators B, vol. 86, PP. 49-57, 2002

[NPL 3] K. Johansen et al., “Surface plasmon resonance: instrumental resolution using photo diode arrays”, Measurement Science Technology, vol. 11, PP. 1630-1638, 2000

### SUMMARY OF INVENTION

### Technical Problem

Regarding a noise in a still image or a moving image, the noise generated by a imaging device itself is mainly defined. On the other hand, in the chemical or biochemical analysis for actually measuring a sample as described above, the ratio of noise components other than noise generated by the measurement device itself becomes high.

In the above-described measurement, if noise is included in the waveform to be actually measured, the measured value obtained by processing the signal also includes the noise, so that different values are obtained for each measurement. Further, when the measurement object changes with time, it is necessary to separate the fluctuation of the true value of the value to be measured from the noise. For example, the noise can be suppressed by measuring the average value many times. However, the time used for averaging, that is the number of data items, is limited to the time width using the time resolution for averaging, and there is a limit in the noise suppression.

In general, when a model function representing a peak shape is known in calculation of a peak position and a peak height from the peak shape, the model function is optimized by a least squares method or the like, and parameters of the model function can be obtained. When the model function is complete, the residual error between the model function and the measured value is normally distributed regardless of the shape constituting the peak.

However, when physical and chemical measurements are actually performed using substances, the model function capable of completely describing the measurement system cannot be obtained in many cases. When the parameters describing the model function are not linear, the parameters cannot be uniquely determined by the algebraic formula, and empirical parameters are obtained with appropriate accuracy by calculating the repetitive formula.

When there is an interaction between the parameters, it is necessary to separately impose a constraint depending on the measurement system to optimize the model function. In this way, when the model function is used in physical and chemical measurements, it is necessary to set a prior probability to determine parameters.

However, in order to set the prior probability, it is necessary to perform an operation in which knowledge about the obtained data is mathematized and the like, and appropriate setting is often difficult in terms of time and the number of work terms. Also, even if the same measurement data are used, there is a problem that the estimated value is changed depending on the prior probability to be applied.

In the surface plasmon resonance (SPR) method, the change in the reflectance is determined by the presence or absence of the substance actually. As for a signal, it is known that the incident angle dependency of the p-polarized light reflectance is modeled by using the formula of Fresnel multilayer film reflection (NPL 1). In addition, a method of approximating by using five parameters has been proposed (NPL 2). In either case, it is necessary to perform nonlinear optimization, and the parameters cannot be uniquely determined, and the parameters to be obtained depend on the optimization calculation method.

When a number of parameters is reduced and the peak position is approximated by a quadratic (polynomial) curve, the parameter can be uniquely determined by the least squares method, but the residual error is not uniform, and the noise of the time fluctuation of the estimated value of the parameter becomes large. In order to prevent this, there has been proposed a method of limiting the estimated section to the vicinity of the peak and moving the estimated section as the peak position moves in time (NPL 3). This method is one of the settings of the prior probability. However, in this method, the estimated value may vary discontinuously before and after the change of the estimated section occurs.

In the measurement using a device of a general configuration for receiving light by an array type light receiving element, the movement of the estimated section processes data from light receiving elements having different physical properties. In this case, when the change in the peak position is smaller than the width of the estimated section due to the difference in quantum efficiency among each of the plurality of light receiving elements, the discontinuous change in the parameter becomes remarkable. The state in which the change of the peak position is smaller than the width of the estimated section is the case in which the change of the refractive index is small or the change is slow.

In the estimation of only the peak position, there is known a method of further reducing the parameters and obtaining the graphic center of gravity. In this method, a threshold value equal to or less than the height of the peak is determined, and the average of peak positions with the peak part equal to or more than the threshold value as a weight is calculated. In this method, the information about the peak height is ignored, but the peak position can be uniquely determined by simple calculation. However, it is necessary to calculate the threshold value separately empirically in consideration of the noise level of data and the physical configuration of the device.

As described above, the conventional technique has a problem in that measurement using waveform data having the peak indicating the feature of the measurement object as a result of measurement cannot be easily performed with less noise and high time resolution.

The present invention is achieved to solve the problem as described above, and an object of the present invention is to easily perform the measurement with less noise and high time resolution in the measurement using waveform data having the peak indicating the feature of the measurement object as a result of measurement.

### Solution to Problem

A calibration system according to the present invention includes an acquisition device that acquires peak-like shape data measured by a measurement method capable of obtaining waveform data having a peak indicating a feature of an object to be measured as a measurement result, and an arithmetic device that reconstructs the peak-like shape data using a part of a plurality of bases obtained by performing Karuhunen-Loeve transform on the peak-like shape data.

The calibration system method according to the present invention includes a first step of acquiring peak-like shape data measured by the measurement method capable of obtaining waveform data having the peak indicating the feature of the measurement object as a measurement result, and a second step of reconstructing the peak-like shape data by using a part of the plurality of bases obtained by performing the Karuhunen-Loeve transform on the peak-like shape data.

### Advantageous Effects of Invention

As described above, according to the present invention, since the peak-like shape data is subjected to the Karuhunen-Loeve transform, the measurement with less noise and high time resolution can be easily performed in the measurement using waveform data having the peak indicating the feature of the measurement object as a measurement result.

### BRIEF DESCRIPTION OF DRAWINGS

FIG. 1 is a configuration diagram illustrating a configuration of a calibration system according to an embodiment of the present invention.

FIG. 2 is a flowchart for explaining a calibration method according to the embodiment of the present invention.

FIG. 3 is a cross-sectional diagram illustrating a configuration of a measurement chip 200 for measurement system used in Experiment 1.

FIG. 4 is a configuration diagram illustrating a configuration of the measurement system used in the Experiment 1.

FIG. 5A is data illustrating p-polarized reflectance at a particular time measured with the measurement system used in Experiment 1.

FIG. 5B is data illustrating the reflectance of p-polarized light like p-polarized reflectance at a particular position, measured with the measurement system used in Experiment 1.

FIG. 5C is a feature diagram illustrating the SPR angle calculated by a method for applying the measurement results by the measurement system used in Experiment 1 to the quadratic curve near the peak position and obtaining an incident angle position giving an extreme value of the applied quadratic curve.

FIG. 6 is a diagram for explaining an example of an image acquired in the SPR device.

FIG. 7A is a feature diagram illustrating a result of comparing a time change of the SPR angle with a calculation method by a quadratic least squares method, a graphic center of gravity, and KL transform.

FIG. 7B is a feature diagram illustrating the result of comparing a standard deviation of the SPR angle with the calculation method by the quadratic least squares method, the graphic center of gravity, and the KL transform.

FIG. 8 is a feature diagram illustrating the calculation result in which the measurement results in Experiment 2 is calculated by the quadratic least squares method, the graphic center of gravity method, and the measurement results in Experiment 2 is calculated by the KL transform.

FIG. 9 is a perspective view illustrating a configuration of flow cells 300 used in Experiment 3.

FIG. 10A is a feature diagram illustrating a change in response value for each event of liquid feed in the measurement in Experimental 3.

FIG. 10B is a feature diagram illustrating a change in response value for each event of liquid feed in the measurement in Experimental 3.

FIG. 11 is a feature diagram illustrating the change in peak-like shape due to concentration extracted from the results of the measurement in Experiment 3.

FIG. 12A is a feature diagram illustrating an example of complex p-polarized reflectance in accordance with a redox state of the SPR curve observed in electrochemical SPR measurement.

FIG. 12B is an explanatory diagram for explaining the electrochemical SPR measurement in Experiment 4.

FIG. 13 is an explanatory diagram illustrating the procedure of the electrochemical SPR measurement in Experiment 4.

FIG. 14 is a calibration curve obtained by plotting the glutamic acid concentration and the time change speed of the SPR response value based on the time change ratio indicated in the SPR response value obtained by the electrochemical SPR measurement in Experiment 4.

### DESCRIPTION OF EMBODIMENTS

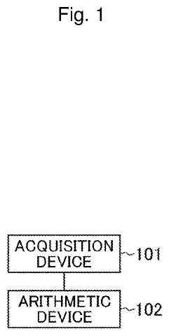

A calibration system according to an embodiment of the present invention will be described with reference to FIG. 1. The calibration system includes an acquisition device 101 and an arithmetic device 102.

The acquisition device 101 acquires peak-like shape data measured by a measurement method capable of obtaining waveform data having a peak indicating a feature of a measurement object as a measurement result. The acquisition device 101 acquires the peak-like shape data measured by the measurement method capable of acquiring the waveform data having the peak indicating at least one of quantitative information (concentration), qualitative information (property, substance name, and the like) as features of the measurement object as a measurement result for processing the measurement object in a quantitative and qualitative manner. The acquisition device 101 can be a device (analysis device) for performing the measurement of the measurement object.

The arithmetic device 102 reconstructs the peak-like shape data by using a part of a plurality of bases obtained by performing the Karuhunen-Loeve transform on the peak-like shape data. The arithmetic device 102 reconstructs the peak-like shape data by using a first base, a second base, a third base, and a fourth base obtained by the Karuhunen-Loeve transform on the peak-like shape data.

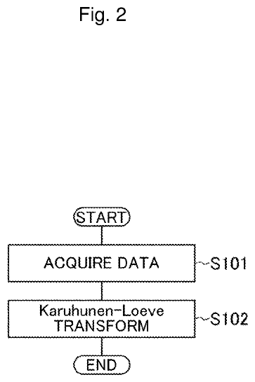

Next, the calibration method according to the embodiment of the present invention will be described with reference to FIG. 2. First, in a first step S101, the peak-like shape data measured by the measurement method capable of obtaining waveform data having the peak indicating the feature of the measurement object as the measurement result is acquired. In the first step S101, the peak-like shape data measured by the measurement method capable of obtaining the waveform data having the peak indicating at least one of quantitative information and qualitative information as features of the measurement object is acquired as the measurement result for processing the measurement object in a quantitative and qualitative manner.

Next, in a second step S102, the peak-like shape data is reconstructed by using a part of a plurality of bases obtained by performing the Karuhunen-Loeve transform on the peak-like shape data. In the second step S102, the peak-like shape data is reconstructed by using the first base, the second base, the third base, and the fourth base obtained by the Karuhunen-Loeve transform on the peak-like shape data. According to the reconstructed peak-like shape data, a feature amount is obtained from, for example, the position of the peak, the size of the peak, and the like, and the analysis of the measurement object is performed.

Note that the above mentioned arithmetic device 102 is computer equipment including a central processing unit (CPU), a main storage device, an external storage device, a network connection device, and the like. The arithmetic device 102 which is the computer equipment can realize the above mentioned functions (the second step of the calibration method) by causing CPU to operate (execute the program) by a program deployed in the main storage device. The program is a program for causing the computer to execute the second step of the calibration method described in the above mentioned embodiment. The network connection device is connected to a network.

As described above, in the measurement using waveform data having the peak indicating the feature of the measurement object as the measurement result, the measurement with less noise and high time resolution cannot be easily performed.

On the other hand, if the Karuhunen-Loeve (KL) transform is used for this kind of calculation, the position of the peak shape can be determined from the obtained data without using a model function (Reference 1). As a precondition for using the KL transform, data in an actual measurement system related to the peak shape which can be taken is acquired in advance. Then, instead of setting up the model of the measurement system, data obtained by the measurement system are analyzed, and weighted averaging of the data is performed so that the signal becomes the largest with respect to noise. The weight is determined from data of the peak-like shape acquired in advance.

Therefore, in the measurement using a sample substance actually, by using KL transform, there is a merit that both an ideal response related to the physical law of the measurement principle and a non-ideal response depending on an actual measurement system are simultaneously processed, and a parameter determined empirically is not required.

As described above, by establishing the KL transform and the actual measurement method suitable for the KL transform, the position and height of the peak shape required for analysis can be obtained while acquiring the error component depending on the actual measurement for actually measuring the substance every time. Further, the present invention can be a technique suitable for automation of the measurement system as a result.

In order to obtain the position and height of the peak-like shape by using the KL transform, it is necessary to record a data string obtained from the measurement system and learn the KL transform coefficient. In a technique for measuring from a change of refractive index such as the Surface Plasmon Resonance (SPR), a mechanism for changing the refractive index is required. The present invention relates to the device including a data collection method required for measuring a peak-like shape for using the KL transform in this way.

In particular, in the SPR measurement, the refractive index of the liquid sample is determined from the peak-like shape appearing in image data of the reflectance with respect to the incident angle. As the possible peak-like shape data is collected in advance by acquiring data obtained by continuously changing the refractive index of a liquid sample in a measurement target range, in the measurement of a refractive index of a sample whose refractive index is unknown, the data can be applied to the rapid measurement and have the time resolution without performing a temporal, thus, the calculation can be performed uniquely with low noise. In addition, since the reconstructed peak-like shape data can have a data volume smaller than that of the original data, a calculation load for obtaining quantitative information and qualitative information can be reduced, thus, the storage capacity for storage can be reduced.

More detailed description will be given below using results of a experiment.

### Experiment 1

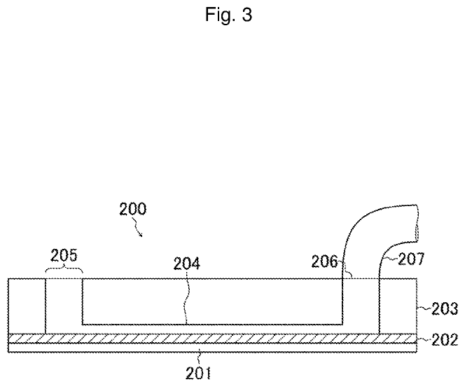

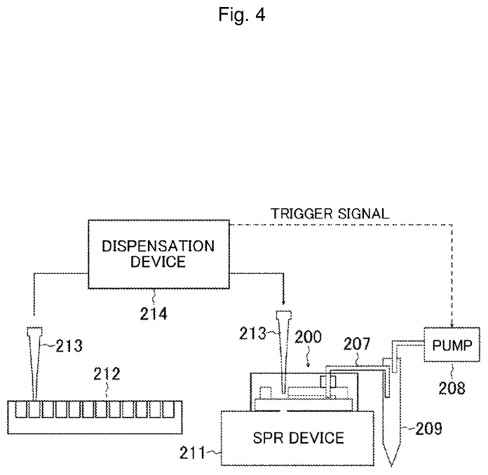

First, Experiment 1 will be described. The measurement system used fro Experiment 1 will be described with reference to FIGS. 3 and 4. First, in the Experiment 1, the measurement chip 200 shown in FIG. 3 was used. The measurement chip 200 is composed of a substrate 201 made of BK7 glass, an Au layer 202 having a film thickness of about 50 nm, and a flow path substrate 203. The Au layer 202 can be formed by a well-known deposition technique such as a sputtering method.

The flow path substrate 203 includes a groove part which become the micro flow path 204, an introduction port 205, and a discharge port 206. For example, the flow path substrate 203 can be formed from polydimethylsiloxane (PDMS). These may be formed, for example, by well-known biopsy trepan. Further, the substrate 201 and the flow path substrate 203 are individually manufactured, and finally, the measurement chip 200 is assembled so that the micro flow path 204 overlaps the measurement region.

For example, the bonding surfaces of the substrate 201 on which the Au layer 202 is formed and the flow path substrate 203 on which the flow path groove is formed are activated by ultraviolet rays irradiation and the like respectively, and then the bonding surfaces are brought into contact with each other and bonded to each other, thereby integrating both. As the ultraviolet light source, a Min-Excimer manufactured by Ushio Inc. was used. The irradiation time of ultraviolet rays was 5 seconds. By using a double-sided tape having a hollowed portion serving as a flow path, the above-mentioned bonding can be performed. An introduction port 205 for injecting a liquid of a measurement (analysis) object is formed by a laser processing device.

A pump 208 is connected to the discharge port 206 through a tube 207 made of fluororesin, and the liquid in the micro flow path 204 can be pulled (sucked) through the discharge port 206. A waste liquid tank 209 connected by the tube 207 is provided between the pump 208 and the discharge port 206. The pump 208 may be, for example, a MFCS-EASY manufactured by Fluigent Inc. The pump 208 can maintain a constant pressure below atmospheric pressure in the connected tube 207. The pump 208 can also receive a trigger signal from the dispensation device 214 and change the pressure to be held constant by a program.

In the measurement, a matching oil (not shown) having a refractive index equal to that of BK7 glass is applied on a measurement surface formed on a measurement prism of the SPR device 211, and the back surface of the substrate 201 of the measurement chip 200 is arranged on the matching oil. The measurement chip 200 is arranged on the optical axis of the light emitted from the light source of the SPR device 211 in a state where the measurement region of the measurement chip 200 is overlapped. The SPR device 211 is, for example, “Smart SPR SS-100” manufactured by NTT advanced technology Corporation.

In the measurement, the measurement chip 200 is arranged in a state where the measurement region of the measurement chip 200 overlaps the optical axis of light emitted from the light source of the SPR device 211. The light emitted from the light source is condensed into a line shape of a predetermined length by a cylindrical lens or the like, made incident on the prism, and irradiated to the measurement region of the measurement chip 200 closely attached to a measurement surface of the prism. The Au layer 202 is formed in the micro flow path 204 which is the measurement region of the measurement chip 200, and the back surface of the Au layer 202 is irradiated with condensed light transmitted through the measurement chip 200.

The condensed light irradiated in this way is reflected on the back surface of the Au layer 202 with which the fluid of the flow velocity measurement object is brought into contact, and photoelectrically converted by a sensor composed of an imaging element such as a so-called CCD image sensor, and intensity (intensity of light) is obtained. A change in the refractive index is obtained by the change in the light intensity obtained in this way. The sensor is, for example, a line-type imaging element having a light receiving part of 480 pixels, and can measure a multi-point refractive index.

A pipette master manufactured by Musashi engineering, Inc. was used as the dispensation device 214 for dispensing the liquid. The dispensation device 214 dispenses a sample prepared on the 96-hole micro plate 212 by a pipette 213, and supplies the dispensed sample to the introduction port 205. The dispensation device 214 can output a trigger signal during dispensing operation of the piston of the pipette 213.

In the measurement, the pressure by the pump 208 was sequentially changed by a predetermined program. The dispensation device 214 and the pump 208 cooperate as described above, and operate as follows.

1. The pump 208 is set to a negative pressure p5, the liquid in the micro flow path 204 is replaced with air, and the inside of the micro flow path 204 is dried. This is set to an initial state.

2. The set pressure of the pump 208 is set to a pressure p2 which is larger than the maximum surface tension (p1) generated at the introduction port 205 to be a capillary tip part by the micro flow path 204, and in which the time for priming suction for drawing the volume of the liquid injected in the next step into the micro flow path 204 is 1 second or less.

3. Water of the same volume as the volume in the micro flow path 204 is injected into the introduction port 205 by the dispensation device 214. After 1 second of the injection, the pressure of the pump 208 is set to p1.

4. The water injected into the introduction port 205 is sucked from the introduction port 205 into the micro flow path 204 by negative pressure by the pump 208, but since the pressure is changed to p1 after 1 second, the rear end face of the water reaches the introduction port 205, and stops in a state where the surface tension and the suction pressure of the pump 208 are balanced. As a result, the liquid is filled in the entire micro flow path 204.

5. The pressure of the pump 208 is set to p3. The shape of the gas-liquid interface at the introduction port 205 is deformed, and the gas-liquid interface stops at a new position where p3 and the surface tension at the introduction port 205 are balanced.

6. Measurement of the SPR device 211 and recording of the measurement result are started.

7. A sample prepared in the 96-hole micro plate 212 is injected into the introduction port 205 by 10 μL using the dispensation device 214 and the pipette 213. Since the narrow part of the introduction port 205 is filled with the sample liquid and the surface tension is greatly reduced, the sample is fed to the micro flow path 204 by the pressure of p3.

8. When the entire volume of the sample enters the micro flow path 204, the recording of the SPR device 211 is stopped.

9. The pressure of the pump 208 is set to p4, and the liquid in the flow path is discharged. The pressure p4 is set to the maximum pressure at which air does not entwine in the micro flow path 204 when 10 μL of water is continuously injected to and discharged by the dispensation device 214.

10. The water is continuously injected into the micro flow path 204 by the dispensation device 214 to wash the micro flow path 204. The water is injected at a sufficient number of times, a trigger is transmitted at the time of final dispensation, and the pressure is set to p5 which can set to an initial state where the micro flow path 204 dries.

For example, p1 and p2 can be set to 750 Pa and 3000 Pa, respectively.

As described above, by using the device having the synchronized liquid feeding mechanism, the liquid feeding of water and the liquid feeding of the sample can be automatically performed.

By the above-described series of operations, the refractive index measured at the part to be measured of the SPR device 211 changes from the refractive index of the water to the refractive index of the sample, and data of the refractive index changing is recorded. In the SPR device 211, the refractive index of the part of 4.8 mm length in a direction along the flow in the micro flow path 204 is measured 150 times per 1 second at 10 μm intervals.

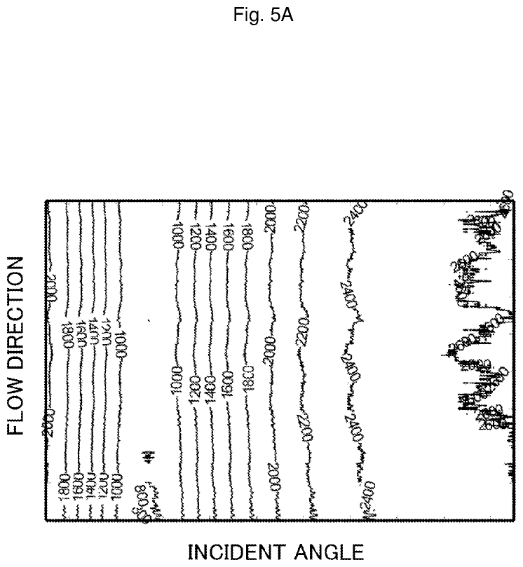

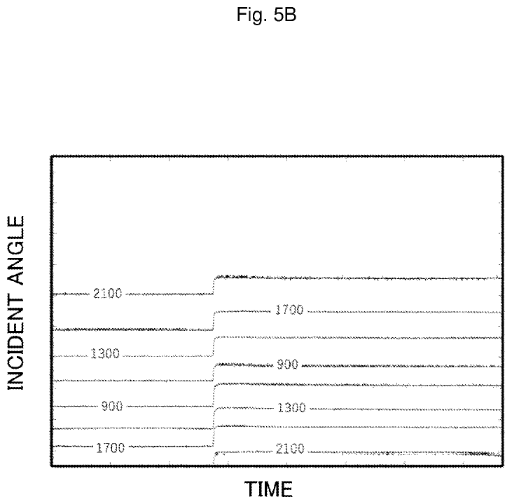

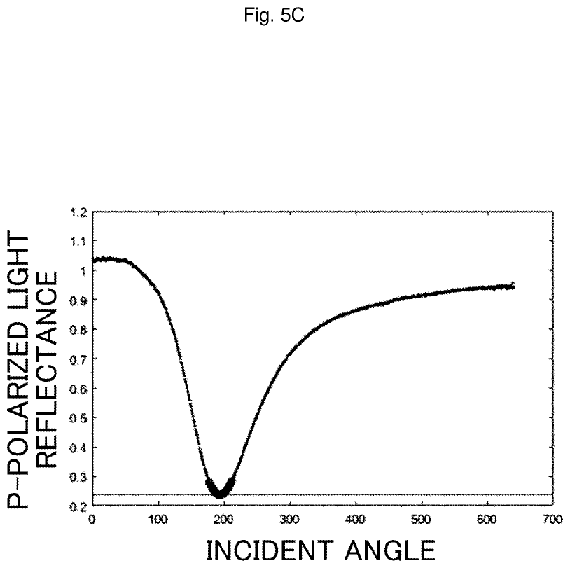

As a result, the p-polarized reflectance at a specific time as shown in FIG. 5A was obtained as an image. In this data, the vertical axis indicates the position in the flow direction, the horizontal axis indicates the incident angle, and the p-polarized light reflectance is indicated by contour lines. Also, the reflectance of p-polarized light was obtained as an image like the reflectance of p-polarized light at a specific position shown in FIG. 5B. In this data, the vertical axis indicates the incident angle, the horizontal axis indicates the time, and the p-polarized light reflectance is indicated by the contour line. 150 pieces of the two-dimensional data are obtained in one second.

In the SPR measurement, the incident angle dependency of the reflectance is measured at each point in the flow direction from the above data, and the concentration of the liquid on the gold thin film surface is calculated from the data. From one element on the horizontal axis of the p-polarized light reflectance at a specific time shown in FIG. 5A, one piece of density data (the p-polarized light reflectance at a specific time and position). The graph of the data thus obtained is waveform data having one downward peak shape in the vertical axis direction. The peak position of the waveform data is called an SPR angle, which is correlated with the local refractive index of the gold surface. The waveform data has a peak in which the quantitative information (concentration) is indicated as a feature of the measurement object. This correlation can be described by Fresnel multilayer film reflection.

First, in order to obtain this peak position, the SPR angle calculated by the method of fitting the data to the quadratic curve in the vicinity of the peak position and obtaining the incident angle position giving the extreme value of the fitted quadratic curve is shown in the p-polarized light reflectance at a specific time and position in FIG. 5C. In this method, an incident angle at which a peak maximum point is obtained is first obtained, and 17 points before and after the obtained angle are used to obtain an incident angle giving the extreme value of the peak position in the least squares. Therefore, when the peak maximum point moves by one pixel width or more, data from the receiving part having different imaging element (pixel) is calculated.

In the SPR measurement, when the imaginary part of the complex refractive index of the sample is small and only the real part changes with the concentration, the p-polarized light reflectance with respect to the incident angle moves in parallel in the incident angle direction. When the concentration change is small, the SPR angle moves in one pixel of the imaging element. When the concentration change becomes large, it moves beyond the width of the incident angle of one pixel. In the SPR measurement, if both of them can be processed continuously, measurement having a large dynamic range can be performed.

Next, a threshold value is provided for the reflectance, and the SPR angle is obtained by a method of calculating the average position by making a value exceeding the threshold value heavier with respect to an incident angle showing the reflectance larger than the provided threshold value. Then, for the same reflectance data, values correlated to the concentration were calculated using the KL transform. The procedure for this is as follows.

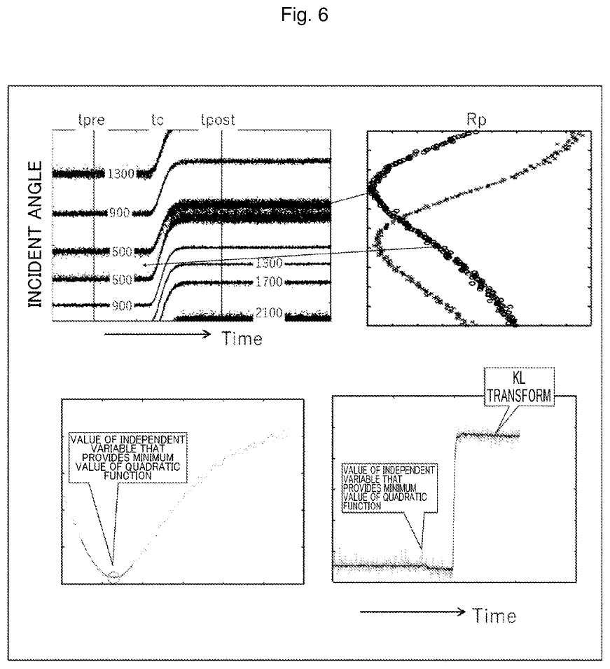

An image (FIG. 6) obtained by the SPR device is stored in an reflection intensity array qy at a incident angle q and a position in the flow direction y. Further, the continuous images of the image at every 1/150 seconds are stored in qyt as an array of time T. The array qyt is three-dimensional. From this array, an array qt=qyt (:, y, :) at a position y in the flow direction is taken out. In this formula, “:” means all the indexes of the array at that position. The array qt is two-dimensional. The two-dimensional array is rearranged one-dimensionally so that the incident angle is continuous and the repetition is continuous in time, and the rearranged one-dimensional array is an original signal a. The original signal a is a one-dimensional array having a length of time×incident angle width.

The original signal a is subjected to the KL decomposition. For this purpose, singular value decomposition is utilized. The original signal a can be calculated as “[U, V, D]=svd(b)]” by the singular value decomposition svd. b=U*V*D is satisfied. U is an orthogonal matrix, and the column vector of U is an independent base (a normal orthogonal base). V is a diagonal matrix whose singular value is a diagonal component, and D is an orthogonal matrix. The array b is a deviation from the average value of the original signal a. The singular value decomposition svd can be calculated by a known method described in Reference 2 or the like.

b=a-mean(a) is satisfied and mean provide an average of a. When the original signal a is reconstructed by the singular value decomposition, “Qy=transpose(U)*b+mean(a)” is obtained, and respective components of the independent base U of the original signal a are calculated. The row vector of Qy represents a temporal change in concentration at a y position in the flow direction, and represents a change in a base component orthogonal to the first base from the first base relating to the temporal change. Qy of b is calculated for each position y and stacked for each component of each base, so that an array of Q(y, t, n) can be constructed. This represents the density at the position y, time t, and base n.

In the case of SPR measurement, the graph of the original signal a has a shape including one peak. When the concentration of the sample changes, the position of the peak moves on the q-axis. This shape can be obtained as a series of the number of layers in consideration of Fresnel multilayer film reflection. This includes noise of the imaging element noise, variation in quantum efficiency of each pixel of the imaging element, accuracy and noise of an AD converter, distortion of an image by an optical system, thermal fluctuation of SPR phenomena, scattering due to dust and scratches on the optical path, thickness and complex refractive index distribution of the Au layer, refractive index distribution of the sample, and effect of heat generation due to excitation light.

For this reason, because of the pattern and change of the light intensity inherent to the measurement system, there are many unambiguous factors in constructing the model describing the whole. In particular, when a portable SPR device is constructed, the correction optical system and the strict dust removing mechanism are contradictory to the robustness and weight reduction of the equipment.

As described above, it is possible to extract a component which changes most largely from the data by the KL transform as an independent base without using a previously defined model.

When the signal obtained by the SPR measurement is performed by the KL transform, the original signal can be expressed by up to the fourth main base in many cases, and the fifth and subsequent bases become noise or a pattern unique to the device. Therefore, by storing the data from the first base to the fourth base instead of storing the original data, both the reduction of the amount of data to be stored and the holding of the original data can be achieved.

On the other hand, in the KL transform, since the relative value to the representative value of the original signal is set in the calculation process, the sign of the result of the singular value decomposition becomes unstable, therefore, an absolute value is correlated to the change direction of concentration, but the sign may be sometimes reversed (Reference 3).

In such a case of the SPR measurement having position resolution in the y direction, the sign of correlation to the density is not uniform for each Y position in singular value decomposition calculated for each y. In order to solve this problem, by applying Hadamard product to the whole U, the sign of U at the specific time can be made uniform in the change direction regardless of y. Alternatively, the direction of change of the concentration may be determined from the array of the concentration calculated by another algorithm (this is defined as B), and the sign of Q may be selected so as to match the direction of change of the concentration from the array of the concentration calculated by another algorithm.

Further, in order to make Q quantitatively coincide with the concentration, a method of correcting Q by a polynomial by using a correlation coefficient between the y-average value of Q and the y-average value of B can be adopted. Further, a series of known solutions having different concentrations can be made to flow through the flow path, and the correlation between the concentration of the series and Q can be used.

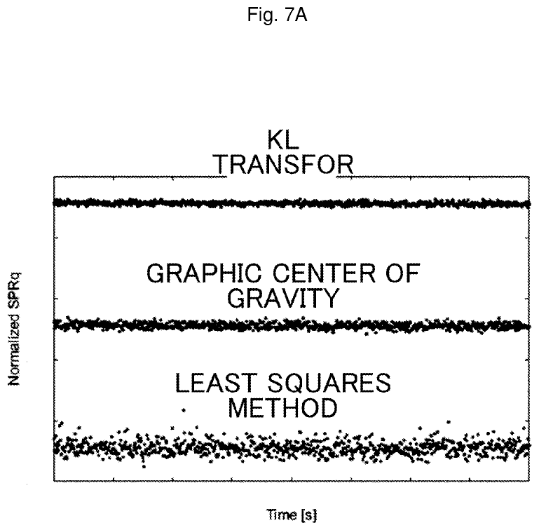

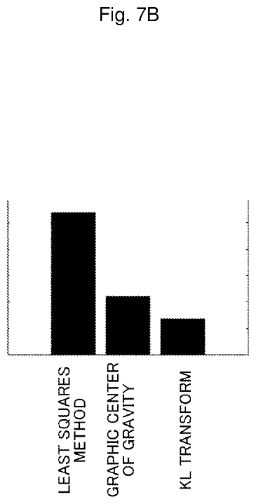

As a result of this calculation of samples of the predetermined concentration, as compared in FIG. 7A and FIG. 7B, by using the first base of the KL transform, the concentration data with less noise than the model-based calculation method could be obtained. In FIG. 7A and FIG. 7B, the calculation methods in which an SPR curve at a time when there is no refractive index change, a temporal change and a standard deviation of an SPR angle at an observation time are calculated by the quadratic least squares method, the graphic center of gravity method, and the KL transform is compared. As shown in the graph of the standard deviation, the standard deviation is the smallest among SPR angles calculated from the same image.

Even in a model-based method, if the measured concentration change is delayed with respect to the measurement interval (exposure interval or exposure time of camera), noise can be reduced by taking the time average of the original data. Even in such a case, the method using the KL transform has an advantage that noise can be reduced while keeping the time resolution high. Further, in order to appropriately calculate the average value mean (a) of the original signal a, it is desirable that the acquisition range of a covers a value which can be sufficiently taken.

For this reason, when a time when the concentration changes in the micro flow path is defined as tc, a time when the SPR signal of the water is recorded is defined as tpre, and a time after the liquid in the micro flow path is replaced with a sample is defined as tpost, it is desirable to select each time for satisfying “Tpre>tc, Tpost>tc, Tpre˜tpost”. With this selection, when dust is contained in a part of inside of the flow path, if Q is calculated by using U calculated when dust is not contained at the before or after measurement, the component after the second base and subsequences becomes large. By using this, dust in the flow path and abnormality in the flow path can be detected.

### Experiment 2

Next, Example 2 will be described. In Experimental 2, the detection (analysis) of an antigen was performed. As the micro flow path, a micro flow path chip (flow cell) disclosed in Reference 4 is used. As in Experiment 1, Smart SPR was used as the SPR device. The water (sample) was made to flow through the flow path of flow cell with the dry state, subsequently to a blocking buffer (Stabilcoat). An antibody was immobilized on the wall surface of the micro flow path of the flow cell.

As described above, when antibody atoms are present in the sample supplied to the micro flow path to which the antibody is immobilized and the antigen molecules bind to the immobilized antibody, the antigen molecules are measured as a change in refractive index in the SPR measurement. This change in refractive index is smaller than the change in refractive index from the blocking buffer to the sample, and is a slow change requiring one second or more in terms of time. The change of the refractive index due to the exchange of the solution is completed within 1 second or less. Following the second liquid, a solution containing an antigen to the fixed antibody is made to flow through the flow path, and the incident angle dependency of the reflectance is measured by SPR at the part where the antibody is fixed and at the other part.

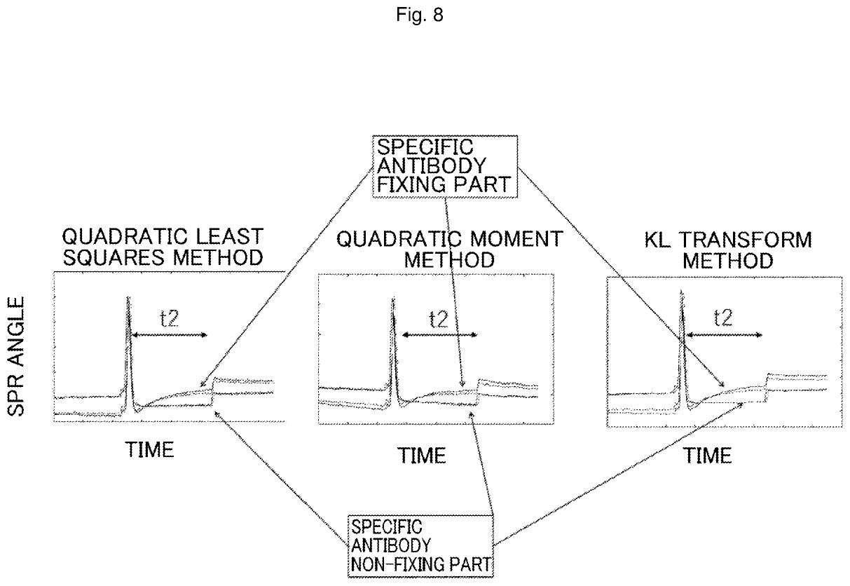

By the data obtained by this measurement, a model-based calculation method described in NPL 3 (the quadratic least squares method, the graphic center of gravity method) and a calculation by the KL transform ware performed. FIG. 8 shows a calculation result. In FIG. 8, the vertical axis of each graph is standardized by standard deviation. The reaction between the antibody and the molecule in the sample is the period of t2. When the temporal change of the refractive index and the difference between the specific antibody fixed part and the specific antibody non-fixed part are compared, the temporal change of the refractive index is similarly calculated in any calculation method, and the difference between the presence and absence of the specific antibody is similar. However, when each plot is viewed in detail, it can be seen that the plot is smooth and the noise is small in the calculation method by the KL transform. Therefore, the lower limit of measurable concentration can be lowered.

### Experiment 3

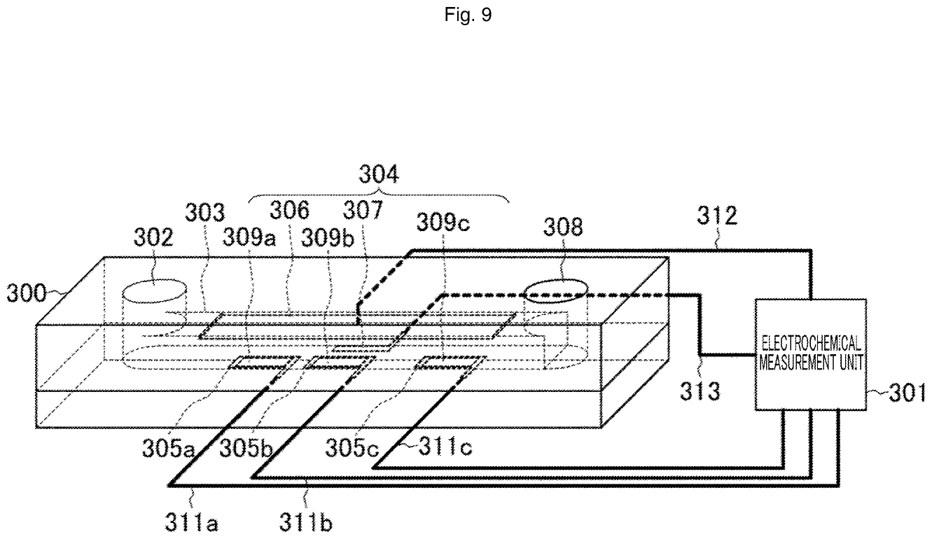

Next, Example 3 will be described. In the Experiment 3, chromatographic current measurement was performed. The present invention is not limited to the incident angle reflectance data of SPR, but can be used for quantifying the change of peak-like shape. An example of measurement of concentration change using the micro flow path will be described below. In the Experiment 3, the flow cell 300 shown in FIG. 9 was used.

The flow cell 300 includes an introduction port 302 into which a liquid of the measurement object is introduced, a micro flow path 303 whose one end is connected to the introduction port 302 and through which the liquid is transferred, and a measurement region 304 formed in a part of the micro flow path 303. A discharge port 308 is formed at the other end of the micro flow path 303. A suction pump (not shown) is connected to the discharge port 308, for example, so that the sample solution supplied to the introduction port 302 can be fed to the micro flow path 303. The micro flow path 303 is formed, for example, in a cross-sectional view to have a width of about 1 mm and a height of 10 to 100 μm. Also, a well-known suction flow path can be provided at the other end of the micro flow path 303, and the suction flow path can be used as the suction pump. A plurality of through-holes reaching the suction flow path is provided in the suction flow path, and the suction flow path functions as the suction pump by using a capillary phenomenon in the through-holes.

In the micro flow path 303 of the measurement region 304, a working electrode 305a, a working electrode 305b, a working electrode 305c, a counter electrode 306 and a reference electrode 307 are arranged. The working electrode 305a, 305b, and 305c are constituted of a metal such as Au, for example, and formed on the first wall surface of the micro flow path 303. The counter electrode 306 is formed on a second wall surface opposite to the first wall surface of the micro flow path 303. Generally, the flow cell 300 is arranged so that the second wall surface is on the ground side. The reference electrode 307 is formed on any wall surface of the measurement region 304. For example, the reference electrode 307 is arranged on the second wall surface without contacting the working electrode 305a, 305b, and 305c.

A functional layers 309a, 309b, and 309c are formed on the working electrode 305a, 305b, and 305c. For example, the functional layer 309b is composed of an enzyme fixing layer on the side of the working electrode 305b and a mediator layer formed on the enzyme fixing layer. The same applies to the functional layers 309a and 309c. Note that each functional layer is composed of the enzyme fixing layer and the mediator layer different from each other.

The flow cell 300 is constituted by bonding a support substrate and a flow path substrate having a groove forming part to be a micro flow path 303. The support substrate can be made of a transparent material such as glass, for example. The flow path substrate can be composed of, for example, hydrophilic polydimethylsiloxane.

The flow cell 300 includes first lead-out wirings 311a, 311b, and 311c, a second lead-out wiring 312, and a third lead-out wiring 313.

Each of the first lead-out wirings 311a, 311b, and 311c is connected to the working electrode 305a, 305b, and 305c, led out to the outside through the flow cell 300 on the side vertical to the first wall surface, and connected to an electrochemical measurement unit 301. The electrochemical measurement unit 301 is, for example, a potentiostat. The second lead-out wiring 312 is connected to the counter electrode 306, led out to the outside through the flow cell 300 on the side of the second wall surface, and connected to the electrochemical measurement unit 301. The third lead-out wiring 313 is connected to the reference electrode 307, led out to the outside through the flow cell 300 on the side vertical to the first wall surface, and connected to the electrochemical measurement unit 301.

Here, the electrochemical measurement unit 301 performs electrochemical measurement using the working electrode 305a, 305b, and 305c, the counter electrode 306, and the reference electrode 307. In this Experiment 3, no SPR measurement is performed, and attention is paid to current measurement. Different aqueous solutions were sequentially fed to the micro flow path 303 by using the dispensation device and the pump similar to those in Experiment 1. A polymer having an osmium dipyridyl (osmium dipyridine) complex containing HRP (hydrogen peroxide reductase) in a side chain is fixed to each working electrode. Therefore, when the hydrogen peroxide solution is made to flow through the micro flow path while a constant potential is applied and the current is measured, a current corresponding to the concentration of hydrogen peroxide flows while the hydrogen peroxide solution flows. However, since the hydrogen peroxide introduced into the micro flow path 303 flows while being diluted in the micro flow path, the time change of the current becomes the peak-like shape.

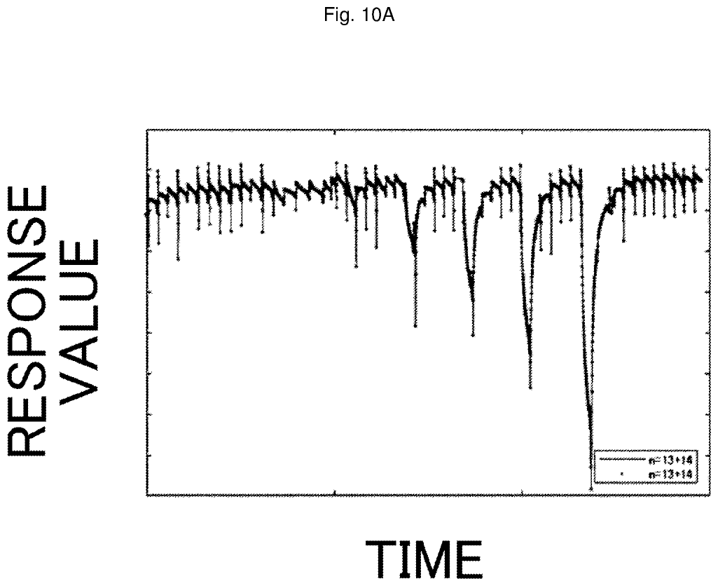

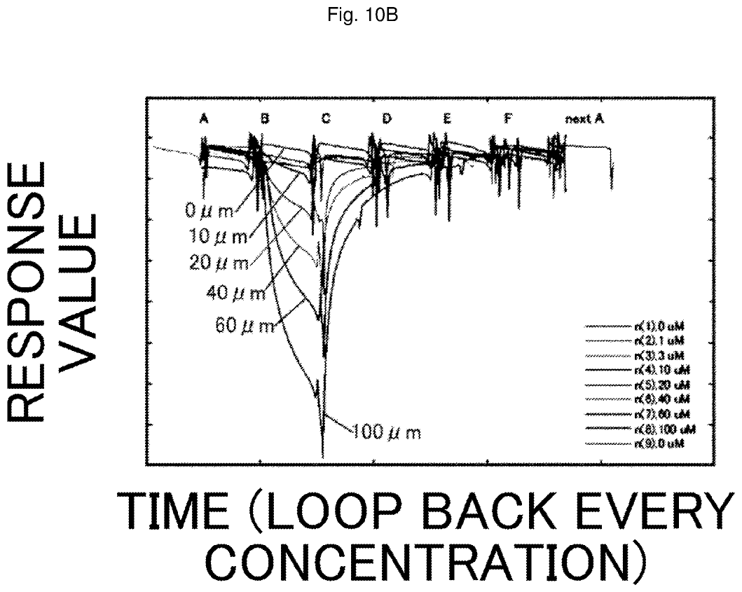

Further, when the water is subsequently fed to clean the hydrogen peroxide in the micro flow path 303, as shown in FIGS. 10A and 10B, each time the liquid feeding event occurs, the absolute value of the flowing current temporarily increases but returns to the state of zero current value. In order to obtain a calibration curve of the hydrogen peroxide concentration from the graph, generally, a background value is set, a shape representing features of the graph is determined, for example, the maximum peak current value, the peak area, or the like is selected and determined, and this is measured and related to the concentration by the least squares method or the like.

However, if the noise is large near the peak current, it often occurs that processing such as determining the section and averaging is required, and the peak shape is not clear. In the method for obtaining the graph features from the representative shape, every time the kind of the working electrode having the modified surface changes, the peak shape whose change is predicted by the reaction speed and diffusion speed of the substance also changes, and therefore, it is necessary to determine the feature quantity again.

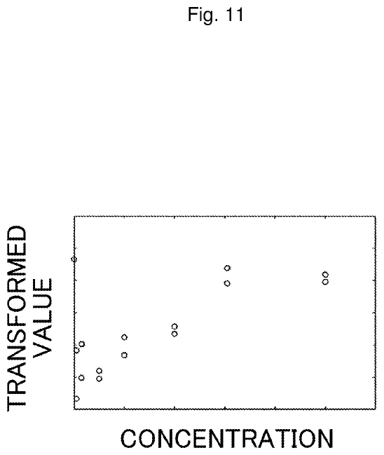

On the other hand, if the singular value decomposition is performed by regarding the entire (including the cleaning process) of the current change in which the concentrations of the samples of the graphs shown in FIGS. 10A and 10B are the same as the peak-like shape column vector d and regarding the array in which d is arranged for each concentration as the original signal a of the Experiment 1, the change in the peak-like shape due to the concentration was extracted as shown in FIG. 11.

In this case, the main peak immediately after the sample is injected into the micro flow path 303 and the current during the cleaning of the micro flow path 303 are also used as the calibration curve. In order to perform such processing, as a precondition, it is necessary to make the time for flowing samples of each concentration equal and to minimize the deviation in the time direction as much as possible. In this example, the timing is made identical by using the dispensation device and the pump, thereby satisfying this condition.

### Experiment 4

Next, Example 4 will be described. In Experiment 4, electrochemical SPR measurements were performed. As described in Experiment 2, in the SPR measurement, a modification layer which catalyzes a molecular recognition molecule and a specific reaction is constructed on the surface of the measurement object, and a change in refractive index of this layer is measured to detect the specific molecule and the specific reaction. When combined with the micro flow path, the sensitivity region of SPR is about 200 nm and has a feature that the volume of the detection region is extremely small, therefore, it is advantageous for measuring a sample of a minute volume.

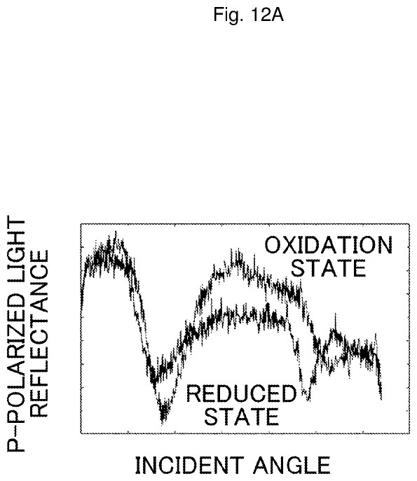

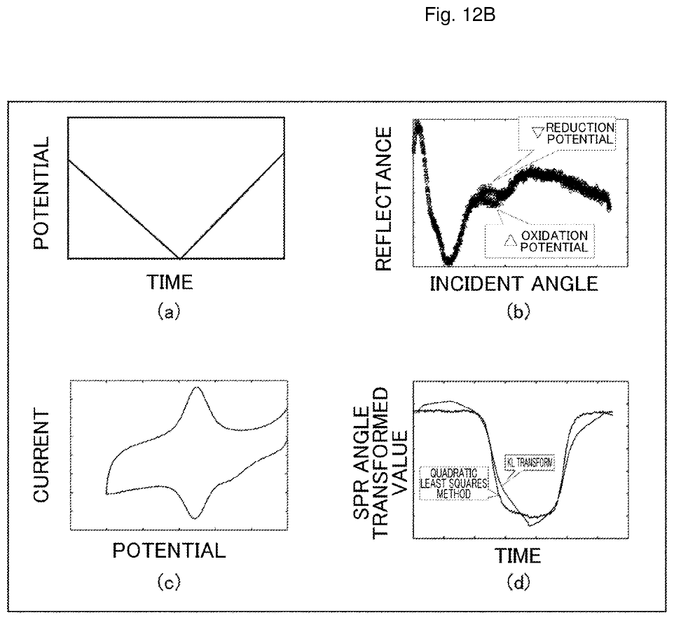

However, in the case where the thickness of the modification layer is uneven, the chemical activity in the modification layer is uneven, or the imaginary part of the complex refractive index of the modification layer changes, the SPR curve has the shape different from that of a curve expected from the Fresnel reflection model having no distribution of thickness of the modified layer. The observed SPR curve becomes a shape in which the position of the peak cannot be determined, for example, as in an example of complicated p-polarized light reflectance shown in FIG. 12A, according to the oxidation-reduction state. Further, a model having many parameters is required to describe the relationship with the refractive index change of the modified layer.

In order to realize the electrochemical measurement by the SPR method, glutamic acid oxidase was further immobilized on the working electrode by the micro flow path chip with an electrochemical electrode having the working electrode modified with a polymer having an osmium dipyridyl (osmium dipyridine) side chain used in the Experiment 4. The concentration of the substrate (glutamic acid) of the enzyme with the enzyme-modified electrode was measured by a read out method of the SPR method.

First, when the charge and discharge reaction is repeated at the working electrode while measuring the p-polarized light reflectance from the laminated film obtained by modifying osmium ions, HRP and glutamate oxidase on the working electrode by the SPR device, the incident angle dependency of the reflectance (the refractive index change) recorded by the SPR device depending on the oxidation and reduction of the osmium ions periodically changes at the cycle of the charge and discharge. Since this change reflects the oxidation-reduction state of the osmium ion, it can be associated with the potential by the Nernst equation, and consequently, the electrode potential can be measured by optical measurement by the SPR method (Reference 5). In other words, the change in the potential of the working electrode with respect to the counter electrode in electrochemical measurement using the working electrode, the reference electrode and the counter electrode of the solution of the measurement object can be measured as the change in the refractive index of the solution by the surface plasmon resonance method.

In order to confirm that the relationship between the shape of the SPR curve and the potential can be calculated with the low noise in this case, the current is measured while sweeping the potential simultaneously with the measurement of the incident angle reflectance by the SPR method, and the potential is measured from the SPR curve. Alternatively, simultaneously with the measurement of the incident angle reflectance by the SPR method, the potential is measured while charging and discharging with a constant current, and the potential is measured from the SPR curve.

Since the change of the SPR curve accompanying this reaction also changes the imaginary part of the complex refractive index and does not cause parallel movement in the incident angle direction, the feature quantity cannot be calculated by a method for obtaining the maximum point of the SPR curve. Also, the SPR curve deviates from a typical dip shape due to the distribution of the thickness of the modification layer, and the change thereof becomes position-dependent. In addition, the SPR curve has a large change and the peak may not fall within the incident angle range defined by the optical system of the device.

Then, the two-dimensional array of the image of the incident angle-reflectance of the entire region of the electrode to which the osmium ions are fixed is set as g1, and the two-dimensional array in which g1 is serialized to be a vertical vector and time changes of the vertical vector is arranged in a column is set to g2. Cyclic voltammetry is performed in which the potential is separated from the oxidation-reduction potential of the osmium ion, starting from a stationary potential time at the oxidation-side potential, exceeding the formula weight oxidation-reduction, and returned to the first potential by returning at the reduction-side potential, and the potential, the current and the SPR curve are simultaneously measured.

In order to correctly maintain the relationship between the time of the potentiostat and the time of the SPR device, it is desirable to operate both devices in synchronization with a trigger signal. When the trigger signal is not used, a potential program is used which is easy to estimate a potential start time from data of the SPR device, such as a pulse for a potential or a momentary start of potential control.

The cyclic voltammetry was carried out with a temporal change in the potential like the potential program shown in FIG. 12B (a), and a small peak separation which is a feature of a surface reaction as a current response was small, and a cyclic voltammogram which shows oxidation reduction of osmium ions symmetrical to the current axis [FIG. 12B (c)] was obtained. In the simultaneously measured SPR measurement, a change g2 of the incident angle-reflectance curve was obtained as shown in FIG. 12B (b). Since the potential of the working electrode scans both sides of the oxidation-reduction potential of the osmium ion, g2 includes the whole state of the oxidation-reduction state of the osmium ion on the electrode.

When the feature value of the first base is plotted as a function of the potential by calculating from g2 in the same manner as in Experiment 1, a graph in which the SPR angle and the SPR angle transform value are obtained as shown in FIG. 12B (d) was obtained. In FIG. 12B (d), a case where the KL transform was performed and a case where the values obtained by a method of approximating each SPR curve by the quadratic least squares method are standardized are displayed. It can be seen that the noise of the value calculated by the KL transform is small. Further, it can be seen that measurement can be performed when the SPR curve cannot be modeled or when it depends on the state of the immobilization layer.

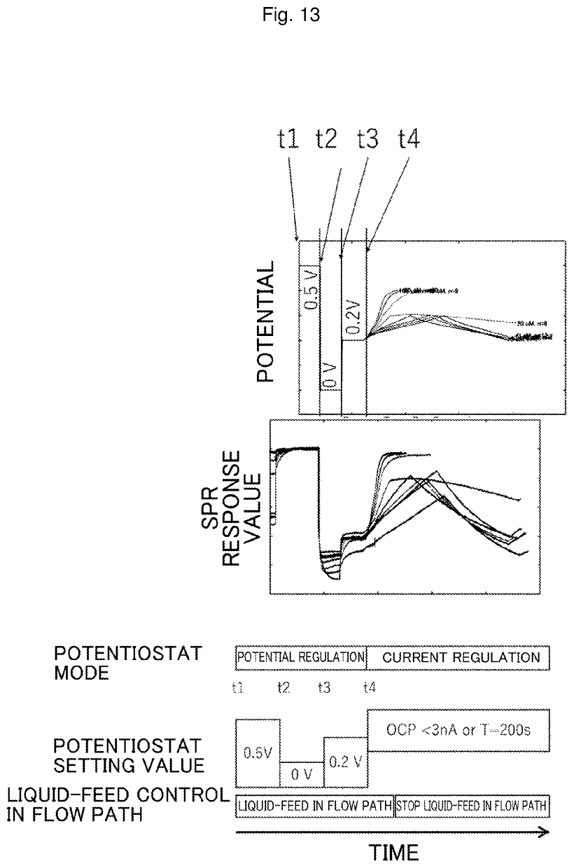

Next, the electrode was charged and discharged at a constant current to quantify the substrate of the enzymatic reaction. Experiment (measurement) was performed by using the potential current program shown in FIG. 13, using the incident angle-reflectance data obtained by the SPR device, using a method of measuring the potential. In this example, since the complex refractive index distribution of the modification layer depends on the immobilization operation, the following program (procedure) was used to appropriately learn the refractive index change of the immobilization layer by the KL transform.

### (Step 1)

First, an electrolyte containing no oxidation-reduction substance is introduced into the flow path by using the pump. At t1 shown in FIG. 13, the potential of the potentiostat is set to a potential at which osmium ions are oxidized in a potential regulation mode, and the fixed osmium ions are oxidized.

### (Step 2)

Then, the fixed osmium ions while keeping the potential at the reduction potential at t2 shown in FIG. 13 are reduced, and the refractive index measured by the SPR method is set to a constant value.

### (Step 3)

Then, the fixed osmium ions while keeping the potential at the reduction potential are reduced, and the refractive index measured by the SPR method is made constant.

### (Step 4)

Next, the potential is set to the oxidation-reduction potential of the osmium ion at t3 shown in FIG. 13, and half of the fixed osmium ion is oxidized. The refractive index also changes stepwise by the displacement of the potential. Thus, the time held by the potentiostat and the time held by the SPR method can be synchronized. This synchronization can be also taken by a method in which the potentiostat of the synchronization signal and the SPR device are separately shared.

### (Step 5)

Next, a fixed amount of a sample electrolyte containing the substrate of glutamic acid oxidase (glutamic acid) is charged into the inlet of the flow path and is liquid-fed. Thus, a fixed amount of sample enters the micro flow path and stops.

### (Step 6)

Next, at t4 shown in FIG. 13, the potentiostat is set to a current regulation mode of a current 3 nA. In this state, the osmium ions are oxidized at a constant rate defined by the current by the current from the electrode, and the electrode potential becomes high accordingly. When the potential exceeds 0.3 V, the polarity of the current is reversed by a program.

The reaction of HRP with hydrogen peroxide oxidizes HRP, the HRP reacts with osmium ions in the reduced state, and the immobilized osmium ions are gradually oxidized. Accordingly, the potential rises, and the signal measured by the SPR method also changes to the signal in the oxidation-reduction state.

The change of the oxidation-reduction state by the electric charge supplied from the potentiostat and the change of the oxidation-reduction state by the electric charge supplied from the HRP are detected by the SPR method in a superposed state.

When the concentration of glutamic acid is low after the regulated current is reversed to negative, the potential is lowered because the oxidation rate of osmium ions by hydrogen peroxide is slower than the reduction rate by potentiostat. On the other hand, when the concentration of glutamic acid is high and the oxidation rate of osmium ions by hydrogen peroxide is higher than the reduction rate by potentiostat, the potential continues to rise. This gradient of the potential continues until all of the fixed osmium ions are reduced or oxidized by the current of the potentiostat when the concentration is low.

Since a constant current is supplied from the potentiostat, the change of the potential is completed within a constant time even when the hydrogen peroxide concentration is 0, and the quantification is completed within a finite time. Since the same signal is obtained every time the positive and negative of the current from the potentiostat are switched, reproducibility can be improved.

The above measurement is observed as the potential measured by the potentiostat (the potential of FIG. 13), and similarly, is also observed by the SPR signal. The whole is converted into KL in the same manner as in the previous Experiment, and the potential can be obtained from SPR measurement. This result is shown in the SPR response value of FIG. 13. By using the program (procedure), the SPR curve of all states of oxidation and reduction of the modification layer required for the KL transform can be acquired in the potential regulation mode, so that the SPR angle at the time of current regulation can be correctly transformed.

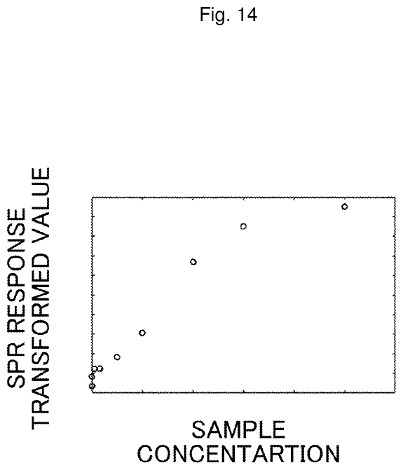

Since the rate of time change indicated by the SPR response value in FIG. 13 depends on the concentration of glutamic acid, when the rate of time change between the concentration of glutamic acid and the SPR response value was plotted, a calibration curve of the concentration of glutamic acid can be obtained as shown in FIG. 14.

As described above, according to the present invention, since the peak-like shape data is subjected to the Karuhunen-Loeve transform, the measurement with less noise and high time resolution can be easily performed in the measurement using the waveform data having the peak indicating the feature of the measurement object as a measurement result.

Also, it is apparent that the present invention is not limited to the embodiment described above, and many modifications and combinations can be carried out by those having ordinary knowledge in the art within the technical idea of the present invention.

### REFERENCES

[Reference 1] V. V. Zaharov et al., “Karhunen-Lo'eve treatment to remove noise and facilitate data analysis in sensing, spectroscopy and other applications”, Analyst, vol. 139, pp. 5927-5935, 2014
[Reference 2] C. M. Bishop “Pattern recognition and machine learning first volume statistical prediction based on Bayesian theory”, issued by Skjacquet Co., Ltd., and published on the best.
[Reference 3] R. Bro et al., “Resolving the sign ambiguity in the singular value decomposition”, Journal of Chemometrics, vol. 22, pp. 135-140, 2008
[Reference 4] WO2009/096527
[Reference 5] S. Koide et al., “A novel biosensor using electrochemical surface plasmon resonance measurements”, Chemical Communications, pp. 741-742, 2000

### REFERENCE SIGNS LIST

101 Acquisition device
102 Arithmetic device

1. A calibration system comprising:
an acquisition device configured to acquire peak-like shape data measured by a measurement method capable of obtaining waveform data having a peak indicating a feature of a measurement object as a measurement result; and
an arithmetic device configured to reconstruct the peak-like shape data by using a part of a plurality of bases obtained by performing Karuhunen-Loeve transform on the peak-like shape data.

2. The calibration system according to claim 1, wherein
the arithmetic device reconstructs the peak-like shape data by using a first base, a second base, a third base, and a fourth base obtained by performing the Karuhunen-Loeve transform on the peak-like shape data.

3. The calibration system according to claim 1, wherein
the acquisition device acquires the peak-like shape data measured by the measurement method capable of obtaining waveform data having the peak indicating at least one of quantitative information and qualitative information as features of the measurement object as the measurement result for processing the measurement object in a quantitative and qualitative manner.

4. A calibration method comprising:
a first step of acquiring the peak-like shape data measured by the measurement method capable of obtaining waveform data having the peak indicating the feature of the measurement object as a measurement result; and
a second step of reconstructing the peak-like shape data by using a part of the plurality of bases obtained by performing the Karuhunen-Loeve transform on the peak-like shape data.

5. The calibration method according to claim 4, wherein
in the second step, the peak-like shape data is reconstructed by using the first base, the second base, the third base, and the fourth base obtained by performing the Karuhunen-Loeve transform on the peak-like shape data.

6. The calibration method according to claim 4, wherein
in the first step, the peak-like shape data measured by the measurement method capable of obtaining waveform data having the peak indicating at least one of the quantitative information and the qualitative information as features of the measurement object as the measurement result for processing the measurement object in a quantitative and qualitative manner is acquired.

7. The calibration method according to claim 4, wherein
in the first step, the peak-like shape data is acquired by measuring the change in potential of a working electrode with respect to a counter electrode in electrochemical measurement using the working electrode, the reference electrode, and the counter electrode as the change in refractive index by the surface plasmon resonance method.

8. The calibration system according to claim 2, wherein
the acquisition device acquires the peak-like shape data measured by the measurement method capable of obtaining waveform data having the peak indicating at least one of quantitative information and qualitative information as features of the measurement object as the measurement result for processing the measurement object in a quantitative and qualitative manner.

9. The calibration method according to claim 5, wherein
in the first step, the peak-like shape data measured by the measurement method capable of obtaining waveform data having the peak indicating at least one of the quantitative information and the qualitative information as features of the measurement object as the measurement result for processing the measurement object in a quantitative and qualitative manner is acquired.

10. The calibration method according to claim 5, wherein
in the first step, the peak-like shape data is acquired by measuring the change in potential of a working electrode with respect to a counter electrode in electrochemical measurement using the working electrode, the reference electrode, and the counter electrode as the change in refractive index by the surface plasmon resonance method.

11. The calibration method according to claim 6, wherein
in the first step, the peak-like shape data is acquired by measuring the change in potential of a working electrode with respect to a counter electrode in electrochemical measurement using the working electrode, the reference electrode, and the counter electrode as the change in refractive index by the surface plasmon resonance method.
